(19) United States
(12) Patent Application Publication
(10) Pub. No.: US 2011/0120417 A1
(43) Pub. Date: May 26, 2011

(54) METHOD AND DEVICE FOR CONTROLLING THE FUEL PRESSURE IN THE PRESSURE ACCUMULATOR OF A COMMON-RAIL INJECTION

(76) Inventors: Uwe Jung, Worth a. d. Donau (DE); Janos Radeczky, Wenzenbach (DE); Michael Wirkowski, Regensburg (DE)

(21) Appl. No.: 13/056,078

(22) PCT Filed: Jun. 25, 2009
(86) PCT No.: PCT/EP2009/057949

§ 371 Date: Jan. 26, 2011

(30) Foreign Application Priority Data
Aug. 1, 2008 (DE) 102008035985.8

(51) Int. Cl. F02D 41/38; F02D 41/40

(52) U.S. Cl. 123/447; 701/103; 123/456; 123/486

(57) ABSTRACT

In a method and a device for controlling the fuel pressure in the pressure accumulator of a common-rail injection system, the difference between the actual engine speed and a target engine speed is established, and an injection time is determined based on the determined difference. The fuel pressure is controlled according to the determined injection time.

### CROSS-REFERENCE TO RELATED APPLICATIONS

This application is a U.S. National Stage Application of International Application No. PCT/EP2009/057949 filed Jun. 25, 2009, which designates the United States of America, and claims priority to German Application No. 10 2008 035 985.8 filed Aug. 1, 2008, the contents of which are hereby incorporated by reference in their entirety.

### TECHNICAL FIELD

The invention relates to a method and a device for regulating the fuel pressure in the pressure accumulator of a common-rail injection system.

### BACKGROUND

Common-rail injection systems are already known. These are injection systems for internal combustion engines, in which a high-pressure pump brings the fuel up to a high pressure level. The pressurized fuel fills a pipe system, which during operation of the engine is constantly under pressure.

Such a common-rail injection system is known from DE 10 2006 023 470 A1. The system described there comprises a high-pressure fuel pump for delivering fuel, a high-pressure fuel accumulator connected to the high-pressure fuel pump for accumulating fuel under an injection pressure compared to the environment of the common-rail injection system, at least one injector connected to the high-pressure fuel accumulator for discharging fuel into at least one combustion chamber, a return line for returning fuel from the injector to the high-pressure fuel pump under a return pressure compared to the environment of the common-rail injection system, and a setting means for setting the return pressure.

A further common-rail injection system is known from DE 10 2006 026 928 A1. The system described there contains a fuel tank, a high-pressure fuel pump, a common-rail line, a pressure accumulator, an injector and a digital control unit. In the feed line between the fuel tank and the high-pressure fuel pump a volumetric flow control valve is disposed, which is triggered by the digital control unit via a volumetric flow control valve trigger line. The high-pressure fuel pump comprises at least one displacer unit. During operation of the injection system the displacer unit supplies an injection pressure that is applied in the common-rail line to the injector. The pressure accumulator is connected to a pressure sensor, which projects into the common-rail line and/or the pressure accumulator. During operation of the injection system the pressure sensor detects the injection pressure measured value and transmits it to the digital control unit. If the injection pressure prevailing in the pressure accumulator differs from its setpoint value, then the digital control unit adapts the delivery rate by adjusting an actuator so that the difference is minimized.

In the event of failure of the pressure sensor during operation of such a common-rail injection system, the control unit has no information about the common-rail pressure and regulation of the common-rail pressure as a function of the output signal of the pressure sensor cannot occur. Such a failure of the pressure sensor may be caused for example by drop-out of a connector, the occurrence of a cable break or the occurrence of a short-circuit.

In delivery-rate-regulated systems that do not have an active pressure release valve, because of the numerous disturbance variables, the common-rail pressure cannot be set precisely enough by one form of control alone, for example by setpoint control and/or precontrol of a volume control system. In this situation an injection pressure that is far too low or far too high may lead to an unintended stop of the engine or to operation of an existing pressure relief valve. Operation of the pressure relief valve due to the pressure being too high is accompanied by damage to components. Safe onward travel is therefore not possible.

It is further already known, in the event of failure of the common-rail pressure sensor, to switch off the engine of the motor vehicle by means of the control unit. If this cannot be done promptly, components of the system are damaged.

### SUMMARY

According to various embodiments, a way of enabling compensation of a failure of the common-rail pressure sensor in a common-rail pressure regulating system can be indicated.

According to an embodiment, in a method of regulating the fuel pressure in the pressure accumulator of a vehicle equipped with a common-rail injection system, the difference between the actual engine speed value and a setpoint engine speed value is established and from the determined difference an injection time is determined, wherein the regulation of the fuel pressure is effected as a function of the determined injection time.

According to a further embodiment, for regulating the fuel pressure the let-through behavior of a pressure-regulating actuator can be varied, wherein given a rise in the injection time the let-through quantity of the pressure-regulating actuator is increased and given a drop in the injection time the let-through quantity of the pressure-regulating actuator is decreased. According to a further embodiment, a plurality of setpoint engine speed values can be selected, which are associated with various accelerator pedal positions. According to a further embodiment, three setpoint engine speed values can be selected, the first setpoint speed value being associated with idling, the second setpoint speed value being associated with vehicle operation with a semi-depressed accelerator pedal, and the third setpoint speed value being associated with vehicle operation with a fully depressed accelerator pedal. According to a further embodiment, when determining the injection time, the instantaneous terrain may be taken into account. According to a further embodiment, when determining the injection time, the output signal of an air-mass meter can be taken into account. According to a further embodiment, determining the injection time, the instantaneously engaged gear can be taken into account.

According to another embodiment, the device for regulating the fuel pressure in the pressure accumulator of a vehicle equipped with a common-rail injection system, may comprise a pressure accumulator, an injector, a control unit, an engine speed sensor and a pressure-regulating actuator, the control unit being provided for supplying trigger signals for the injector and the pressure-regulating actuator and on the basis of a comparison between the actual engine speed value and a setpoint engine speed value an injection time being calculated, wherein the control unit determines the trigger signals for the pressure-regulating actuator as a function of the injection time.

According to a further embodiment of the device, the control unit determines the trigger signals for the pressure-regulating actuator as a function of the instantaneous terrain. According to a further embodiment of the device, the device may comprise an air-mass meter and the control unit determines the trigger signals for the pressure-regulating actuator as a function of the output signal of the air-mass meter. According to a further embodiment of the device, the control unit may determine the trigger signals for the pressure-regulating actuator as a function of the instantaneously engaged gear of the vehicle. According to a further embodiment of the device, the control unit may have a memory, in which a plurality of setpoint engine speed values are stored. According to a further embodiment of the device, in the memory three setpoint engine speed values can be stored, the first setpoint speed value being associated with idling, the second setpoint speed value being associated with vehicle operation with a semi-depressed accelerator pedal, and the third setpoint speed value being associated with vehicle operation with a fully depressed accelerator pedal. According to a further embodiment of the device, the control unit may comprise a memory, in which is stored the data of a characteristics map, in which for a plurality of fuel injection quantities in each case associated values for the injection time and the fuel pressure are stored.

### BRIEF DESCRIPTION OF THE DRAWINGS

Further advantageous properties of the various embodiments emerge from the following description by way of example with reference to the figures, in which:

FIG. 1 shows a block diagram of a device for implementing a method according to various embodiments and

FIG. 2 shows a graph, in which the injection time is plotted against the fuel pressure.

### DETAILED DESCRIPTION

The advantages of various embodiments are in particular that, in the event of failure of the common-rail pressure sensor in a common-rail pressure regulating system, by initiating a limp-home operation characterized by the method according to various embodiments, it may be ensured that the respective motor vehicle does not stop and that no components of the injection system are damaged.

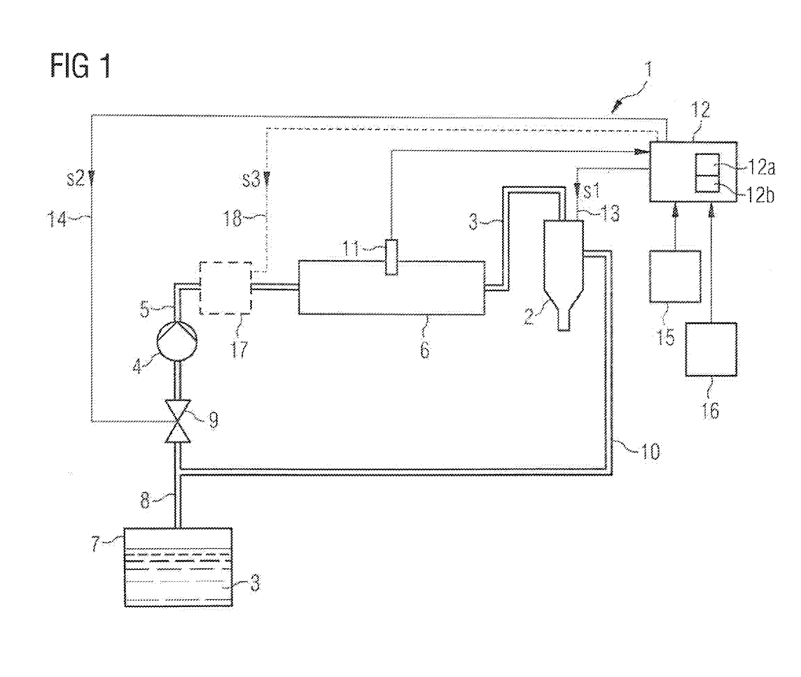

FIG. 1 shows a block diagram of a device for implementing a method according to various embodiments. The illustrated device is a common-rail injection system of a motor vehicle.

The injection system 1 comprises at least one injector 2 for injecting fuel 3 into at least one combustion chamber, which is not represented. The injection system 1 further contains a high-pressure fuel pump 4, which is connected by a common-rail line 5 and a pressure accumulator 6 (=common rail) to the injector 2. The high-pressure fuel pump 4 draws fuel 3 from a fuel tank 7, to which it is connected by a feed line 8. Situated in the feed line 8 is a volumetric-flow control valve 9 for limiting the fuel quantity supplied to the high-pressure fuel pump 4.

The injector 2 may have a leakage flow of fuel that is fed back through a return line 10 to the feed line 8. The return line 10 opens out into the feed line 8 between the fuel tank 7 and the volumetric-flow control valve 9.

Provided in the pressure accumulator 6 is a pressure sensor 11, the output signal of which is supplied to a control unit 12. The control unit 12 is electrically connected by a control line 13 to the injector 2 and by a volumetric-flow control trigger line 14 to the volumetric-flow control valve 9. The control unit 12 supplies trigger signals s1 to the injector 2 and trigger signals s2 to the volumetric-flow control valve 9.

During operation of the injection system the high-pressure fuel pump 4 supplies an injection pressure that prevails in the common-rail line 5, in the pressure accumulator 6 and at the injector 2.

The control unit 12 generates the trigger signals, which it supplies, inter alia, as a function of the output signal of an engine speed sensor 15 and an air-mass meter 16.

A pressure-monitoring valve 17 may optionally be integrated into the common-rail line 5 to limit the pressure of the fuel supplied to the pressure accumulator 6. The pressure-monitoring valve 17 is triggered by the control unit 12 by means of trigger signals s3 via a pressure-monitoring valve trigger line 18.

During normal operation of the illustrated device the control unit 12 regulates the fuel pressure prevailing in the injection system by means of pressure regulation as a function of the output signal of the pressure sensor 11. Necessary variations of the pressure are effected in that the control unit 12 supplies a trigger signal to this effect to one of the pressure-regulating actuators of the device, for example to the volumetric-flow control valve 9 or the pressure-monitoring valve 17.

In the event of a fault that leads to the pressure sensor 11 no longer being able to supply the control unit 12 with information about the actual pressure value in the pressure accumulator 6, the control unit 12 switches over to a limp-home operating mode in order, despite failure of the pressure sensor, to be able to continue carrying out regulation of the fuel pressure in the pressure accumulator 6.

In this limp-home operating mode, regulation of the fuel pressure prevailing in the pressure accumulator 6 is effected by a variation of a pressure-regulating actuator as a function of the instantaneous injection time. The instantaneous injection time is based on a comparison of the actual speed value, which is derived from the output signal of the engine speed sensor 15, with a preset setpoint speed value, wherein this comparison is carried out by the control unit 12. If the actual speed value differs from the preset setpoint speed value, then the control unit 12 varies the injection time in such a way that the speed is adjusted to its setpoint speed value. According to various embodiments, the information about the respective instantaneous injection time is used to influence a pressure-regulating actuator as a function of the injection time with the aim of keeping the fuel pressure in the pressure accumulator 6 constant. Given a rise in the injection time, the let-through quantity of the pressure-regulating actuator is increased. Given a drop in the injection time, the let-through quantity of the pressure-regulating actuator is decreased.

The pressure-regulating actuator is the volumetric-flow control valve 9 or the optionally provided pressure-monitoring valve 17. By virtue of this regulation the fuel pressure in the pressure accumulator 6 is kept in a range that is adequate for the load level existing in each case. In particular, it is ensured that the fuel pressure in the pressure accumulator 6 cannot increase to an extent that leads to bursting of the system or to damage of components of the system. It is moreover ensured that the engine does not cut out and/or is not switched off. The respective vehicle does not stop.

The above-mentioned setpoint speed value is preferably dependent upon the position of the accelerator pedal. For example, three different setpoint speed values are selected, wherein the first setpoint speed value is associated with idling, the second setpoint speed value is associated with vehicle operation with a semi-depressed accelerator pedal, and the third setpoint speed value is associated with vehicle operation with a fully depressed accelerator pedal. These setpoint speed values are stored in a memory 12a of the control unit 12.

The injection time determined on the basis of the comparison of the actual speed value with the setpoint speed value is dependent both upon the described speed values and upon the respective engaged gear and is determined by the control unit 12 as a function of the described parameters in order to keep the pressure in the pressure accumulator 6 at a desired value and/or in a desired pressure value range.

The control unit 12, when determining the injection time, moreover also takes into account the instantaneous terrain, i.e. whether the vehicle at that moment is traveling uphill or downhill. Such changes in the terrain lead to a variation of the setpoint injection quantity value, without a causal pressure change. A variation of the setpoint injection quantity value is carried out for example if the output signals of the air-mass meter 16 allow detection of an actual increase of the injection quantity. Such an actual increase of the injection quantity is always linked to an increased air requirement.

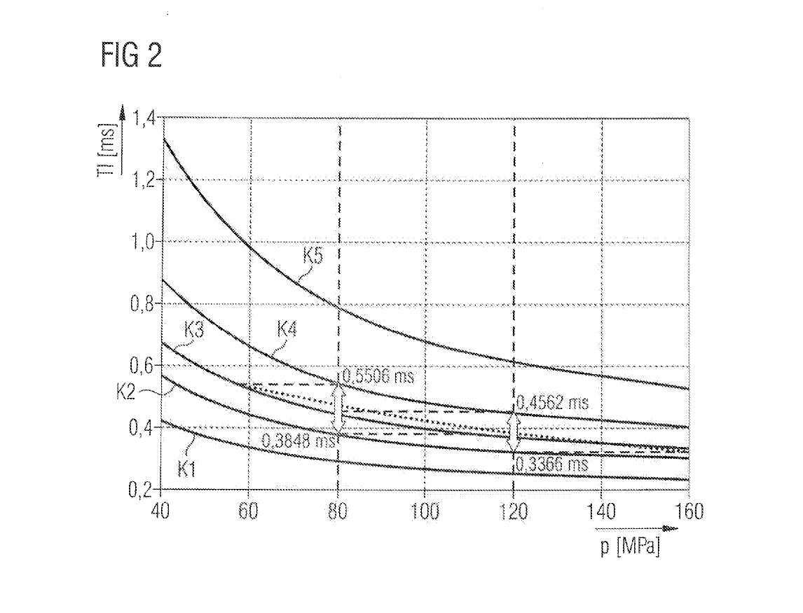

FIG. 2 shows a graph, in which the injection time TI is plotted against the fuel pressure p. Here, the represented curve K1 corresponds to an injection quantity of 5 mg, the curve K2 to an injection quantity of 10 mg, the curve K3 to an injection quantity of 14 mg, the curve K4 to an injection quantity of 20 mg, and the curve K5 to an injection quantity of 28 mg.

The data belonging to this graph is stored in the form of a characteristics map in a memory 12b of the control unit 12. The control unit 12 with the aid of this characteristics map determines the fuel quantity required in each case and supplies trigger signals for the pressure-regulating actuators 9 and/or 17 in order to convey the necessary fuel quantity into the pressure accumulator 6.

From FIG. 2 it emerges for example that, given a pressure of 80 MPa and a variation of the injection time from 0.3848 ms to 0.5506 ms, the injection quantity has to be increased from 10 mg to 20 mg, with the result that the fuel-regulating actuators also have to be correspondingly opened in order to be able to supply the desired fuel quantity and maintain the desired fuel pressure in the common rail.

It is further evident from FIG. 2 that, given a pressure of 120 MPa and a variation of the injection time from 0.3366 ms to 0.4562 ms, the injection quantity has to be increased from 10 mg to 20 mg, with the result that the fuel actuators also have to be correspondingly opened in order to be able to supply the desired fuel quantity and maintain the desired fuel pressure.

What is claimed is:

1. A method of regulating the fuel pressure in the pressure accumulator of a vehicle equipped with a common-rail injection system, the method comprising:
determining the difference between the actual engine speed value and a setpoint engine speed value,
determining an injection time from the determined difference, and
regulating the fuel pressure as a function of the determined injection time.

2. The method according to claim 1, wherein for regulating the fuel pressure the let-through behavior of a pressure-regulating actuator is varied, wherein given a rise in the injection time the let-through quantity of the pressure-regulating actuator is increased and given a drop in the injection time the let-through quantity of the pressure-regulating actuator is decreased.

3. The method according to claim 1, wherein a plurality of setpoint engine speed values are selected, which are associated with various accelerator pedal positions.

4. The method according to claim 3, wherein three setpoint engine speed values are selected, the first setpoint speed value being associated with idling, the second setpoint speed value being associated with vehicle operation with a semi-depressed accelerator pedal, and the third setpoint speed value being associated with vehicle operation with a fully depressed accelerator pedal.

5. The method according to claim 1, wherein, when determining the injection time, the instantaneous terrain is taken into account.

6. The method according to claim 5, wherein, when determining the injection time, the output signal of an air-mass meter is taken into account.

7. The method as claimed according to claim 1, wherein, when determining the injection time, the instantaneously engaged gear is taken into account.

8. A device for regulating the fuel pressure in the pressure accumulator of a vehicle equipped with a common-rail injection system, comprising
a pressure accumulator,
an injector,
a control unit,
an engine speed sensor and
a pressure-regulating actuator,
the control unit being provided for supplying trigger signals for the injector and the pressure-regulating actuator and on the basis of a comparison between the actual engine speed value and a setpoint engine speed value an injection time being calculated, wherein the control unit determines the trigger signals for the pressure-regulating actuator as a function of the injection time.

9. The device according to claim 8, wherein the control unit determines the trigger signals for the pressure-regulating actuator as a function of the instantaneous terrain.

10. The device according to claim 9, wherein it comprises an air-mass meter and the control unit determines the trigger signals for the pressure-regulating actuator as a function of the output signal of the air-mass meter.

11. The device according to claim 8, wherein the control unit determines the trigger signals for the pressure-regulating actuator as a function of the instantaneously engaged gear of the vehicle.

12. The device according to claim 8, with the control unit having a memory, in which a plurality of setpoint engine speed values are stored.

13. The device according to claim 12, wherein in the memory three setpoint engine speed values are stored, the first setpoint speed value being associated with idling, the second setpoint speed value being associated with vehicle operation with a semi-depressed accelerator pedal, and the third setpoint speed value being associated with vehicle operation with a fully depressed accelerator pedal.

14. The device according to claim 8, wherein the control unit comprises a memory, in which is stored the data of a characteristics map, in which for a plurality of fuel injection quantities in each case associated values for the injection time and the fuel pressure are stored.

15. A system for regulating the fuel pressure in the pressure accumulator of a vehicle equipped comprising:
a common-rail injection system, the
means for determining the difference between the actual engine speed value and a setpoint engine speed value,
means for determining an injection time from the determined difference, and
means for regulating the fuel pressure as a function of the determined injection time.

16. The system according to claim 15, wherein for regulating the fuel pressure the let-through behavior of a pressure-regulating actuator is varied, wherein given a rise in the injection time the let-through quantity of the pressure-regulating actuator is increased and given a drop in the injection time the let-through quantity of the pressure-regulating actuator is decreased.

17. The system according to claim 15, wherein a plurality of setpoint engine speed values are selected, which are associated with various accelerator pedal positions.

18. The system according to claim 17, wherein three setpoint engine speed values are selected, the first setpoint speed value being associated with idling, the second setpoint speed value being associated with vehicle operation with a semi-depressed accelerator pedal, and the third setpoint speed value being associated with vehicle operation with a fully depressed accelerator pedal.

19. The system according to claim 15, wherein, when determining the injection time, the instantaneous terrain is taken into account.

20. The system according to claim 15, wherein, when determining the injection time, the output signal of an air-mass meter is taken into account.
